(19) United States
(12) Patent Application Publication
(10) Pub. No.: US 2010/0077261 A1
(43) Pub. Date: Mar. 25, 2010

(54) APPARATUS AND METHOD FOR ENCODING THE FIVE SENSES INFORMATION, SYSTEM AND METHOD FOR PROVIDING REALISTIC SERVICE USING FIVE SENSES INTEGRATION INTERFACE

(76) Inventors: Young Giu Jung, Daejeon (KR); Mun Sung Han, Daejeon (KR); Jun Seok Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/516,471

(22) PCT Filed: Dec. 3, 2007
(86) PCT No.: PCT/KR07/06216

§ 371 Date: May 27, 2009

(30) Foreign Application Priority Data
Dec. 4, 2006 (KR) 10-2006-0121585
Jul. 12, 2007 (KR) 10-2007-0070175

(51) Int. Cl. G06F 11/07; G06F 17/00; G06F 3/16; G06F 19/00; G09B 25/00

(52) U.S. Cl. 714/48; 700/90; 715/727; 702/23; 434/428; 714/E11.022; 715/863

(57) ABSTRACT

The present invention relates to a realistic service and system using a five senses integrated interface, and more particularly, to an apparatus and method for encoding the five senses and a system and method for providing realistic service using a five senses integrated interface, to allow a user to select a product to sensorially experience through an integrated interface in a remote location, which includes a integration recognizer detecting data selected by the user and recognizing an object, and transmitting five senses data of the object through a network, a five senses data analyzer receiving a five senses data packet including the five senses data of the object through the network, and extracting and analyzing the five senses data packet in terms of data on each of the five senses, and a five senses integration representer representing five senses using the data on each of the five senses.

### TECHNICAL FIELD

The present invention relates to realistic service technology using a five senses integrated interface, and more particularly, to an apparatus and method for encoding the five senses and a system and method for providing realistic service using a five senses integrated interface, in order to satisfy internet shopping users with actual sensory experiences in cyberspace through encoded smells, tastes, and haptic sensations.

This work was supported by the IT R&D program of MIC/IITA[2006-S-031-01, Five Sences Information Processing Technology Development for Network Based Reality Service].

### BACKGROUND ART

Generally, in order to select and purchase a certain product in an imaginary space such as the Internet, a user must primarily rely on visual information. However, this visual information is not the most useful when selecting products such as food (for which taste is paramount) and perfumes/colognes (for which smell is most important).

To overcome this problem, a newly emerging five senses data service technology uses previously developed technology (for encoding smells and tastes) together with data communication in cyberspace. Research in this five senses communication field began in 2000 with the inauguration of the Five Senses Research Institute in Japan, for technical analysis and research on applications for the senses of smell, taste, and touch. However, no service is yet provided for realistic cyber shopping that uses five senses data.

### DISCLOSURE OF INVENTION

### Technical Problem

Therefore, in order to satisfy users, there is a specific need to develop technology capable of providing a realistic cyber shopping experience through an integration interface and encoded smells, tastes, and haptic sensations.

Accordingly, in order to overcome the above limitations, the present invention encodes data in each category of the five senses for products being sold in cyberspace and generates an integrated packet to send to a user, and also sends an integrated packet of five senses data on a user-selected product to the user through cyberspace to enable the user to use a five senses device to actually experience the product with the five senses.

### Technical Solution

According to an aspect of the present invention, there is provided an apparatus for encoding five senses data, including: a sense analyzer analyzing an inputted object, to detect a ratio of chemical constituents of a smell of the object, taste data included in a taste of the object, and touch data on the object; and a five senses packet generator generating an integrated packet, using the detected ratio of smell chemical constituents, and the taste and touch data of the object analyzed by the sense analyzer.

Here, the sense analyzer may include: a smell analyzer separating the chemical constituents of the smell of the object into a central smell and other smells, and analyzing the ratio of the chemical constituents; a taste analyzer analyzing a ratio of sweetness, bitterness, saltness, sourness, and spiciness in the taste data; and a touch analyzer analyzing a hardness, a temperature, and a texture in the touch data.

Also, the five senses packet generator may generate the integrated packet through encoding a chemical constitution ratio of the central smell and the other smells through the smell analyzer, encoding the ratio of sweetness, bitterness, saltness, sourness, and spiciness through the taste analyzer, and encoding the hardness, temperature, and texture through the touch analyzer.

According to another aspect of the present invention, there is provided a method of encoding five senses data, the method including: analyzing an inputted object; analyzing a ratio of chemical constituents of an extracted smell of the object, analyzing a taste of the object into a ratio of five taste categories, and analyzing a hardness, a texture, and a temperature of the object; encoding the ratio of the chemical constituents, the ratio of the five taste categories, and the hardness, texture, and temperature of the object; generating an integrated packet from the encoded chemical constituents, five taste categories, and the hardness, texture, and temperature of the object.

Here, the analyzing of the smell ratio may include: extracting the chemical constituents from the smell of the object; and dividing the chemical constituents into categories based on quantity, and designating a chemical constituent of the largest quantity from the chemical constituents as a central smell, and the remainder of the chemical constituents as other smells, and the five taste categories may include sweetness, bitterness, saltness, sourness, and spiciness.

According to a further aspect of the present invention, there is provided a realistic service system using a five senses integrated interface, the realistic service system including: a integration recognizer detecting data selected by a user and recognizing an object, and transmitting five senses data of the object through a network; a five senses data analyzer receiving a five senses data packet including the five senses data of the object through the network, and extracting and analyzing data on each of the five senses from the five senses data packet; and a five senses integration representer representing five senses using the data on each of the five senses.

Here, the integration recognizer may recognize an object selected through audio and gestures of the user, and the gestures may include movement gestures and pointing gestures of the user.

Also, the five senses data packet received by the five senses data analyzer may include data on smell, taste, and touch senses of the selected object.

Additionally, the five senses data analyzer may include a five senses transmitting controller for processing transmitting errors that occur during the transmitting through the network, and the five senses integration representer may generate five senses commands controlling a five senses device according to the analyzed data on each of the five senses.

According to a still further aspect of the present invention, there is provided a realistic service method using a five senses integrated interface, the realistic service method including: recognizing an object through detecting selection data of a user; transmitting data on the recognized object through a network; receiving a five senses data packet on the object sent through the network; analyzing extracted data on each sense included in the received five senses data packet; and outputting each sense through a five senses device, using the analyzed data on each sense.

### Advantageous Effects

In order to enable humanly-perceivable five senses data to be sent through communications networks to a remotely-located user, the above-described apparatus and method for encoding the five senses and a system and method for providing realistic service using a five senses integration interface according to the present invention forms and saves an integrated packet, so that when a user uses the latter during cyberspace shopping, the user can experience sensations of the five senses similar to reality.

### BRIEF DESCRIPTION OF THE DRAWINGS

FIG. 1 is a view showing the configuration of a five senses encoding apparatus according to the present invention.

FIG. 2 is a view showing the configuration of an integrated transmission packet generated according to present invention.

FIG. 3 is a view of a flowchart showing an encoding method of five senses data according to the present invention.

FIG. 4 is a view showing the configuration of a realistic service system using a five senses integration interface according to the present invention.

FIG. 5 is a view of a flowchart showing a realistic service method using a five senses integration interface according to the present invention.

### BEST MODE FOR CARRYING OUT THE INVENTION

Reference will now be made in detail to preferred embodiments of the present invention that can easily be embodied by those skilled in the art, examples of which are illustrated in the accompanying drawings. However, in the detailed descriptions of the operating principles of the preferred embodiments according to the present invention, detailed descriptions of well-known related functions or configurations will not be given when they are deemed to unnecessarily obscure the main focus of the present invention.

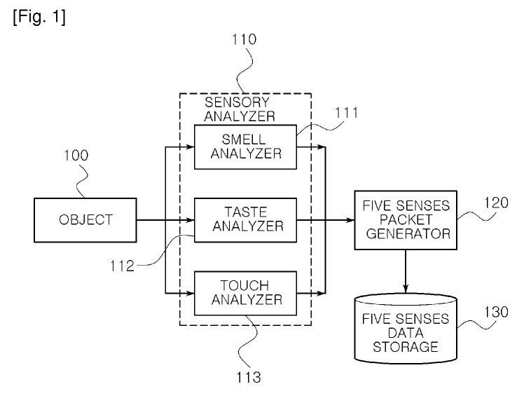

FIG. 1 is a view showing the configuration of a five senses encoding apparatus according to the present invention.

Referring to FIG. 1, a five senses encoding apparatus includes an inputted object 100, a sensory analyzer 110 that analyzes the object, a five senses packet generator 120 that encodes each of the senses analyzed by the sensory analyzer 110 and generates a five senses packet, and a five senses data storage 130 that stores the five senses packet on the object.

First, the object 100 that is the object to be encoded is inputted. Not only can the object inputted be one of various products sold in cyberspace, but it can also be any object to be experienced through the senses.

When the object 100 is inputted, the sensory analyzer 110 analyzes the object in terms of the five senses. The five senses include sight, hearing, smell, taste, and touch. Because the senses of sight and hearing are already encodable using many conventional methods, descriptions thereof will not be given. Only descriptions of sensorial analysis for smell, taste, and touch and five senses packet generation will be given.

The sensory analyzer 110 includes a smell analyzer 111 for analyzing smells, a taste analyzer 112 for analyzing tastes, and a touch analyzer 113 for analyzing the sense of touch.

The smell analyzer 111 uses a scent chemical analyzer to collect scents emitted from the object 100, and orders the chemical components included in the scents. From the ordered chemical components, that which is highest in quantity is designated as the central scent, and the remaining are designated as other scents.

The taste analyzer 112 uses a flavor analyzer to categorize components into five taste categories, after which encoding is based on the mutual ratios of the respective taste categories. The five flavor categories are sweet, bitter, salty, sour, and spicy. After the flavor analyzer analyzes the chemical components, the ratios of the analyzed components are calculated in terms of the five flavor categories. Thus, experiencing flavors at a remote location by tasting with one's hands is possible.

The touch analyzer 113 analyzes three types of touch components. The three touch components are temperature (signifying the heat inherent in a material), hardness (signifying mass or hardness and softness of a material), and texture (signifying softness or coarseness of a surface). The touch analyzer 113 measures the three analyzed tactile categories as ratios based on preset reference values.

Data analyzed by the sensory analyzer 110 on the senses of smell, taste, and touch are relayed to the five senses packet generator 120, and are encoded and generated as an integrated packet.

The five senses packet generator 120 encodes the ratios of central scent and other scent chemical components from the smell analyzer 111, encodes the ratio of sweetness, bitterness, saltiness, sourness, and spiciness from the taste analyzer 112, and encodes the hardness temperature, and texture from the touch analyzer 113, in order to generate an integrated packet.

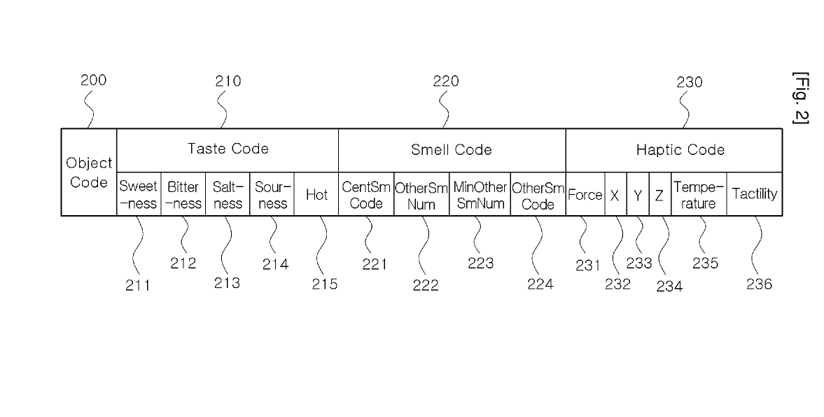

The integrated packet generated by the five senses packet generator 120 is shown in detail in FIG. 2.

The five senses data for each object generated by the five senses packet generator 120 is stored in the form of five senses packets in the five senses data storage 130. The five senses data storage 130 relays data corresponding to an object selected by a user through a network.

FIG. 2 is a view showing the configuration of an integrated transmission packet generated according to present invention.

Referring to FIG. 2, data on analyzed smell, taste, and touch senses that is encoded and integrated in a transmission packet is shown.

The transmission packet includes an object code 200 that identifies the object, and a taste code 210, smell code 220, and haptic code 230 that respectively include data on taste, smell, and touch.

The taste code 210 designates whether a taste code exists and sub code regions. The sub codes of the taste code 210 include sweetness 211 representing the sweetness percentage, bitterness 212 representing the bitterness percentage, saltness 213 representing the saltness percentage, sourness 214 representing the sourness percentage, and hot 215 representing the spiciness percentage.

The smell code 220 designates whether a smell code exists and sub code regions. The sub codes of the smell code 220 include a CentSmCode (central smell code) 221 that encodes the chemical component of the central scent, an OtherSmNum (other smell code number field) 222 depicting the number of other smell codes, a MinOtherSmNum 223 depicting an applicable other scent threshold, and an OtherSmCode 224 depicting the chemical components of the other scents.

The haptic code 230 designates whether a touch code exists and sub code regions. The sub regions of the haptic code 230 include force 231, X 232, Y 233, and Z 234 codes that depict the size of forces and directions, a temperature 235 code depicting the temperature of the object, and a tactility 236 code depicting the texture of the object.

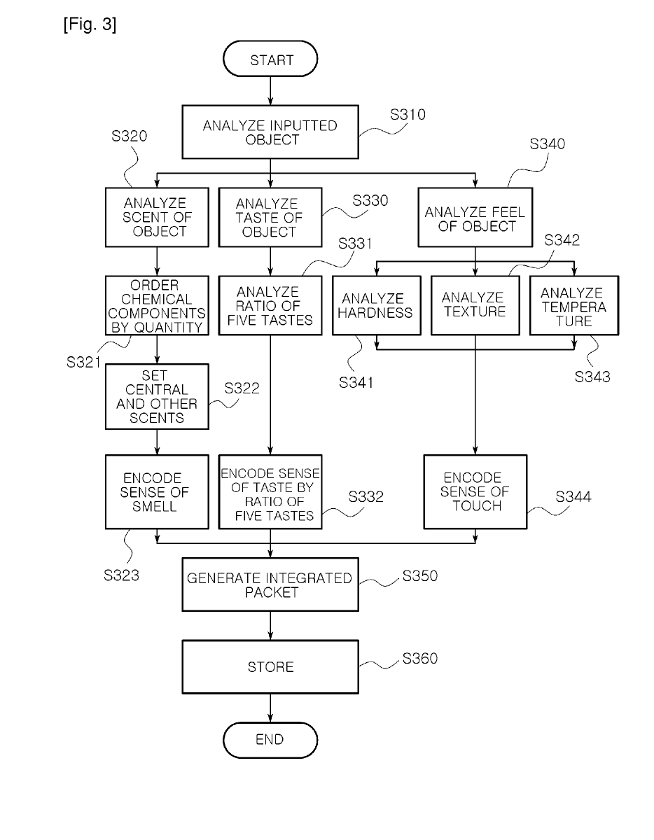

FIG. 3 is a view of a flowchart showing an encoding method of five senses data according to the present invention.

Referring to FIG. 3, inputted objects are analyzed and encoded as smell, taste, and touch data, and the data is generated and stored as an integrated packet. Below, a detailed description of an encoding method for five senses data will be given.

To encode five senses data, an object for which an integrated packet is to be generated is first analyzed in operation S310.

The analysis of the object includes analyzing the smells of the object in operation S320, analyzing the tastes of the object in operation S330, and analyzing the feel of the object in operation S340.

The analysis of the smells of the objects in operation S320 involves collecting scents of the object through the smell analyzer and analyzing the chemical composition of the scents. When the smells are analyzed, the chemical components of the smells are ordered according to quantity in operation S321.

In operation S322, the chemical ingredient of the largest quantity in the smell sample is designated as the central smell, and the remaining chemical ingredients are designated as other smells. When the central and other smells are determined, the smells are encoded in operation S323 according to the ratio of the respective central and other smells, as shown in FIG. 2.

After the analysis of the object's taste in operation S330 using the taste analyzer, the object is analyzed in terms of a ratio of the five different tastes in operation S331. Then, the analyzed five tastes of sweetness, bitterness, saltness, sourness, and hot are encoded as a ratio in operation S322.

After the analysis of the sensation of the object in operation S340, the object is analyzed in operation S341 in terms of softness and hardness, the object is analyzed in terms of texture to determine its softness and coarseness in operation S342, and the object is analyzed in terms of its temperature in operation S343. Then, the analyzed hardness, texture, and temperature of the object are used to encode the haptic code in operation S344.

After the smell, taste, and touch codes are generated, the smell, taste, and touch codes are integrated to generate an integrated packet in operation S350. The integrated packet resembles that shown in FIG. 2.

When the integrated packet of the object is generated, it is stored in the five senses data storage in operation S360.

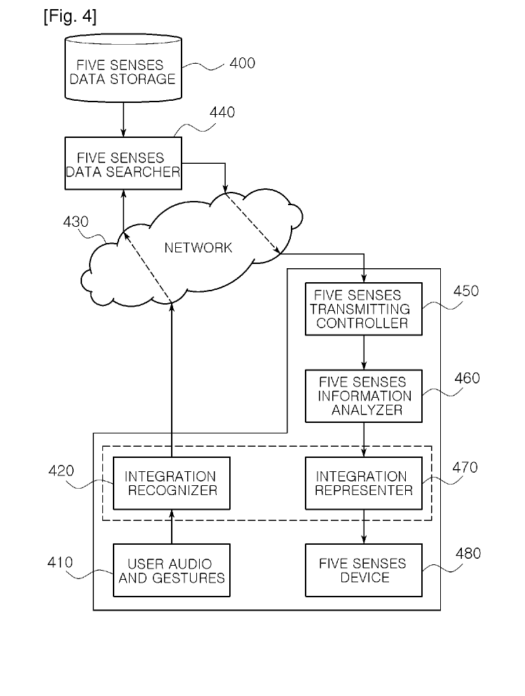

FIG. 4 is a view showing the configuration of a realistic service system using a five senses integration interface according to the present invention.

Referring to FIG. 4, the realistic service system using the five senses integration interface recognizes user audio and gestures 410 (inputted by a user) through a integration recognition unit 420, in order to recognize the object that the user wants to select. This recognized selection data on the object chosen by a user is transmitted through a network 430. With respect to the selection data transmitted through the network, a five senses data searcher 440 searches the five senses data storage 400 for five senses data on the object corresponding to the selection data and relays the same through the network, which is received by a five senses data transmitting controller 450. The five senses data transmitting controller 450 processes errors in the received data that have occurred during transmission, and relays five senses data on the selected object to a five senses data analyzer 460. The five senses data analyzer 460 analyzes the smell, taste, and touch data included in the five senses data, and outputs the processed data through a five senses representer 470 and the five senses device 480. Below, a detailed structural description will be given.

A realistic service system must recognize selection data of objects selected by a user. The desire to select an object is first expressed through the user audio and gestures 410. When a selecting act is performed by a user, the integration recognizer 420 recognizes the selected object through the audio and gestures. With regard to recognizing the object, an audio microphone is used, and a gesture camera is used to determine movement of the user's hands and face to recognize the object.

From the user's audio, specific data is obtained from searching audio commands from a command list. The obtaining of the specific data is usually performed using MFCC and CMS algorithms.

The recognition of gestures is performed through tracing the hand and facial movements of the user and obtaining certain data. These gestures may be composed by using moving and pointing gestures. Here, moving gestures of the hands are captured by a camera and specific data is obtained from the images, and pointing coordinates of a user are used to obtain pointing gestures by calculating coordinates on a screen, in order to search for a selected object. When moving gestures are used, intuitive gestures may be used to obtain specific data.

Moreover, in the present invention, various other methods may be employed to recognize selection data. An obvious example is using a mouse and keyboard to select an object, and another example is a method of recognizing specific data included in audio and gesture analysis to retrieve selected objects. Also, when audio and gestures are combined, certain data may be recognized. Here, the certain data refers to data on the object that the user wishes to select.

The integration recognizer 420 detects and recognizes selection data desired by a user, and transmits the recognized object through the network 430.

The five senses data searcher 440 searches the five senses storage 400 for five senses data corresponding to the recognized object transferred through the network. Here, the recognized object denotes the object selected by the user.

The five senses data found by the five senses data searcher 440 is transferred to the five senses transmitting controller 450 through the network. Because transmission errors may occur in the five senses data transmitted through the network during its transmission, the five senses transmitting controller 450 processes the transmission errors, and relays the five senses data to the five senses data analyzer 460.

The five senses data analyzer 460 analyzes the five senses data, and analyzes the data on the respective five senses included in the five senses data. The five senses data transmitted through the network is configured as an integrated packet, and includes data on smell, taste, and touch. While the integrated packet of the present invention may be configured through various methods, it may be configured as the packet shown in FIG. 2, with the sense of smell as a ratio of chemical components, the sense of taste as a ratio of the five different tastes, and the sense of touch as a ratio of texture, temperature, and hardness with respect to preset reference values.

The integration representer 470 uses the data on the different senses analyzed by the five senses data analyzer 460 to output each of the senses through the five senses device 480, so that a user may actually experience the object through the five senses.

The five senses device 480 includes a display device for outputting visual data, a speaker for outputting aural data, a smell device for reproducing smells, a taste device for outputting tastes, and a touch device for reproducing tactility. There is a large amount of known technology that allows each device to reproduce its respective sense. Therefore, descriptions of the technology will not be given. Also, while the present invention does not provide the senses of sight and hearing to be reproduced in an integrated packet, they may be applied in various ways by those skilled in the art.

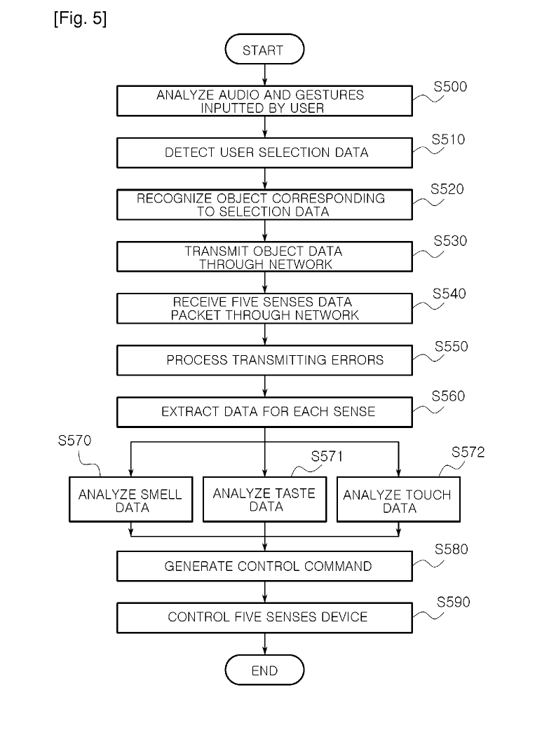

FIG. 5 is a view of a flowchart showing a realistic service method using a five senses integration interface according to the present invention.

Referring to FIG. 5, a realistic service method using a five senses integration interface first selects a subject or object that a user has expressed the desire to experience by using audio and gestures. When the user's audio and gestures are inputted, the inputted audio and gestures are analyzed by the integration recognizer 420 in operation S500.

The integration recognizer 420 analyzes the audio and gestures and extracts specific data from the audio and gestures to detect selection data of the user in operation S510. When the user's selection data is detected, a corresponding object is recognized in operation S520, and the object data is transmitted through a network in operation S530.

The five senses data searcher 440 searches the five senses data storage 400 and extracts a five senses data packet corresponding to the object data transmitted through the network, and then relays the packet through the network.

When the five senses data packet is relayed through the network, the five senses transmitting controller 450 receives the five senses data packet in operation S540, and processes in operation S550 errors that have occurred during transmission.

The five senses data packet that has been processed of errors by the five senses transmitting controller 450 is transferred to the five senses data analyzer 460, and the five senses data analyzer 460 extracts data on each of the senses from the five senses data packet in operation S560.

When each of the senses is individually extracted, the five senses data analyzer 460 analyzes the object data to analyze the chemical constitution of the object's smell in operation S570, analyze the taste data to determine the object's taste in operation S571, and analyzes the touch data in operation S572 to determine the object's texture, temperature, and hardness.

When the smell, taste, and touch data have been analyzed, the integration representer generates a control command for controlling the five senses device in operation S580.

When the control command is generated, the control command is relayed to the five senses device to control the five senses device in operation S590.

Although embodiments have been described with reference to a number of illustrative embodiments thereof, it should be understood that numerous other modifications and embodiments can be devised by those skilled in the art that will fall within the spirit and scope of the principles of this disclosure.

1. An apparatus for encoding five senses data, comprising:
a sense analyzer analyzing an inputted object, to detect a ratio of chemical constituents of a smell of the object, taste data included in a taste of the object, and touch data on the object; and
a five senses packet generator generating an integrated packet, using the detected ratio of smell chemical constituents, and the taste and touch data of the object analyzed by the sense analyzer.

2. The apparatus of claim 1, wherein the sense analyzer comprises:
a smell analyzer separating the chemical constituents of the smell of the object into a central smell and other smells, and analyzing the ratio of the chemical constituents;
a taste analyzer analyzing a ratio of sweetness, bitterness, saltness, sourness, and spiciness in the taste data; and
a touch analyzer analyzing a hardness, a temperature, and a texture in the touch data.

3. The apparatus of claim 2, wherein the five senses packet generator generates the integrated packet through encoding a chemical constitution ratio of the central smell and the other smells through the smell analyzer, encoding the ratio of sweetness, bitterness, saltness, sourness, and spiciness through the taste analyzer, and encoding the hardness, temperature, and texture through the touch analyzer.

4. The apparatus of claim 3, wherein the smell analyzer analyzes smells collected from the object, and designates a chemical constituent of the largest quantity from the chemical constituents of the smell as the central smell, and designates the remainder of the chemical constituents as the other smells.

5. The apparatus of claim 4, wherein the integrated packet includes codes that discern whether the smell, taste, and touch data of the object are present.

6. The apparatus of claim 5, further comprising a five senses database storing the integrated packet generated by the five senses packet generator, to correspond to the inputted object.

7. A method of encoding five senses data, the method comprising:
analyzing an inputted object;
analyzing a ratio of chemical constituents of an smell extracted from the object,
analyzing a taste of the object into a ratio of five taste categories, and analyzing a hardness, a texture, and a temperature of the object;
encoding the ratio of the chemical constituents, the ratio of the five taste categories, and the hardness, texture, and temperature of the object;
generating an integrated packet from the encoded chemical constituents, five taste categories, and the hardness, texture, and temperature of the object.

8. The method of claim 7, wherein the analyzing of the smell ratio comprises:
extracting the chemical constituents from the smell of the object; and
dividing the chemical constituents into categories based on quantity, and designating a chemical constituent of the largest quantity from the chemical constituents as a central smell, and the remainder of the chemical constituents as other smells.

9. The method of claim 7, wherein the five taste categories comprise sweetness, bitterness, saltness, sourness, and spiciness.

10. The method of claim 7, wherein the encoding of the ratios of the chemical constituents and the five taste categories, and the encoding of the hardness, texture, and temperature of the object comprise generating codes discerning whether smell, taste, and touch data are present.

11. The method of claim 7, further comprising storing the integrated packet in a database.

12. A realistic service system using a five senses integrated interface, the realistic service system comprising:
a integration recognizer detecting data selected by a user and recognizing an object, and transmitting five senses data of the object through a network;
a five senses data analyzer receiving a five senses data packet including the five senses data of the object through the network, and extracting and analyzing data on each of the five senses from the five senses data packet; and
a five senses integration representer representing five senses using the data on each of the five senses.

13. The realistic service system of claim 12, wherein the integration recognizer recognizes an object selected through audio and gestures of the user.

14. The realistic service system of claim 13, wherein the gestures comprise movement gestures and pointing gestures of the user.

15. The realistic service system of claim 12, wherein the five senses data packet received by the five senses data analyzer comprises data on smell, taste, and touch senses of the selected object.

16. The realistic service system of claim 15, wherein the data on smell included in the five senses data packet encodes a chemical constituent of the largest quantity from chemical constituents of the smell of the selected object as a central smell, and the remainder of the chemical constituents as other smells.

17. The realistic service system of claim 15, wherein the data on taste included in the five senses data packet is encoded as sweetness, bitterness, saltness, sourness, and spiciness of the selected object.

18. The realistic service system of claim 15, wherein the data on touch included in the five senses data packet is encoded as texture, temperature, and hardness of the selected object.

19. The realistic service system of claim 12, wherein the five senses data analyzer comprises a five senses transmitting controller for processing transmitting errors that occur during the transmitting through the network.

20. The realistic service system of claim 12, wherein the five senses integration representer generates five senses commands controlling a five senses device according to the analyzed data on each of the five senses.

21. A realistic service method using a five senses integrated interface, the realistic service method comprising:
recognizing an object through detecting selection data of a user;
transmitting data on the recognized object through a network;
receiving a five senses data packet on the object sent through the network;
analyzing extracted data on each sense included in the received five senses data packet; and
outputting each sense through a five senses device, using the analyzed data on each sense.

22. The realistic service method of claim 21, wherein the recognizing of the object comprises:
detecting the selection data of the user through analyzing inputted audio and gestures of the user; and
recognizing an object corresponding to the detected selection data.

23. The realistic service method of claim 22, wherein the detecting of the selection data comprises detecting the selection data through integrating certain data extracted from the audio and certain data extracted from the gestures.

24. The realistic service method of claim 21, wherein the analyzing of the extracted data comprises extracting data included in the received five senses data packet separately in sense categories of smell, taste, and touch, wherein
the sense category of smell is extracted as a central smell that is largest in quantity among chemical constituents of a smell of the object, and other smells that are the remaining chemical constituents of the smell,
the sense category of taste is extracted as a ratio of sweetness, bitterness, saltness, sourness, and spiciness, and
the sense category of touch is extracted as hardness, texture, and temperature.

25. The realistic service method of claim 21, wherein the outputting of each sense comprises:
generating five senses control commands for controlling a five senses device according to the analyzed data on each sense; and
controlling the five senses device according to the generated five senses control commands.
